(19) United States
(12) Patent Application Publication
(10) Pub. No.: US 2007/0220775 A1
(43) Pub. Date: Sep. 27, 2007

(54) SUBSTRATE PROCESSING METHOD AND SUBSTRATE PROCESSING APPARATUS

(76) Inventor: Katsuhiko Miya, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/687,381

(22) Filed: Mar. 16, 2007

(30) Foreign Application Priority Data
Mar. 22, 2006 (JP) 2006-078228

(51) Int. Cl. F26B 3/00

(52) U.S. Cl. 34/351; 34/443

(57) ABSTRACT

In a condition that an opposed surface 31 of a proximity block 3 is positioned in the vicinity of a front surface Wf of a substrate and a liquid-tight layer 23 is formed in a space SP between the opposed surface 31 and the front surface Wf of the substrate, the proximity block 3 moves in the moving direction (−X), a solvent gas containing a solvent component, which is dissolved in the liquid and reduces the surface tension, is supplied toward an upstream-side edge 231 of the liquid-tight layer 23. Further, the liquid is supplied to the front surface Wf of the substrate at an upstream-side interface 231a or on the downstream side (−X) in the moving direction relative to the upstream-side interface 231a, thereby replacing a rinsing liquid (the liquid) contacting the front surface Wf of the substrate with thus supplied fresh liquid.

### CROSS REFERENCE TO RELATED APPLICATION

The disclosure of Japanese Patent Application No. 2006-078228 filed Mar. 22, 2006 including specification, drawings and claims is incorporated herein by reference in its entirety.

### BACKGROUND OF THE INVENTION

1. Field of the Invention

The present invention relates to a substrate processing apparatus for and a substrate processing method of drying a surface of a substrate which is wet with a liquid. Substrates to be dried include semiconductor wafers, glass substrates for photomask, glass substrates for liquid crystal display, glass substrates for plasma display, substrates for optical disks, etc.

2. Description of the Related Art

Numerous drying methods have already been proposed in an attempt to remove a rinsing liquid adhering as a liquid film to the top surface of a substrate after cleaning with a processing liquid and rinsing with the rinsing liquid which may be deionized water. One well known method among these is a drying method utilizing the Marangoni effect. This drying method is a method which dries a substrate by means of convective flows (Marangoni convection) caused from a surface tension difference, and the so-called Rotagoni drying, which is a combination of drying utilizing the Marangoni effect and spin drying, is known particularly for a substrate processing apparatus of the single-wafer type.

During Rotagoni drying, IPA vapor (isopropyl alcohol) and deionized water are discharged respectively from associated nozzles upon a rotating substrate from above the center of the substrate. As these nozzles gradually move toward outside along the radial direction of the substrate, drying starts in an area provided with the IPA vapor, the dried region spreads from the center of the substrate toward the rim, and the entire substrate dries. In short, drying is attained as the deionized water on the substrate is removed off from the substrate due to the function of centrifugal force attributed to the rotations of the substrate and the Marangoni effect caused by discharging of the IPA vapor.

As other substrate drying method utilizing the Marangoni effect, the drying method described in JP-A-10-321587 is known. A substrate processing apparatus which performs this drying method is an apparatus in which while plural rollers transport a cleaned and rinsed substrate, the substrate is dried. In this apparatus, a partition plate and a drainage block are arranged in series along a substrate transportation path. Hence, as a substrate seating water droplets is conveyed to the partition plate, the partition plate removes most water droplets. While the substrate is conveyed further to the drainage block after this, due to a narrow clearance between thus transported substrate and the drainage block, water droplets surviving the partition plate get diffused along the width direction of the drainage block owing to the capillary phenomenon. In addition, on the exit side of the drainage block, an inert gas containing an IPA gas is supplied toward the surface of the substrate. The supply of the gas gives rise to the Marangoni effect, whereby remaining water droplets evaporate and dry.

### SUMMARY OF THE INVENTION

By the way, while patterns formed on the surface of the substrate have been speeding toward fine structure in recent years, which has raised new problems in the substrate processing field. That is, during drying, a problem arises that fine patterns are drawn toward each other and collapse. To be more specific, this is a problem that the interface between a liquid and a gas appears on the substrate as drying progresses, and the negative pressure to occur in clearances between fine patterns pull the patterns to each other so that the patterns are collapsed. The negative pressure to occur in the clearances between the patterns is dependent upon the surface tension of the liquid and becomes larger as the surface tension of the liquid grows. Hence, for drying of a substrate wet with deionized water, use of a fluid whose surface tension is smaller than that of deionized water, IPA for instance, is effective in preventing destruction of patterns.

However, since a substrate dries while rotating during Rotagoni drying, there is the following problem. In particular even despite supply of IPA vapor to a surface of a substrate, the IPA vapor gets ejected off from the substrate immediately under the influence of air flows generated by rotations of the substrate, thereby making it impossible to sufficiently dissolve IPA in deionized water adhering to the surface of the substrate. This in turn makes it impossible to sufficiently reduce the surface tension of the liquid (deionized water+IPA) adhering to the surface of the substrate and it is difficult to ensure a sufficient effect of prevention of pattern destruction.

Further, during Rotagoni drying, due to the function of centrifugal force attributed to the rotations of the substrate and the Marangoni effect caused by discharging of the IPA vapor, a dried region spreads from the center of the substrate toward the rim and the substrate dries. Hence, two types of force, namely, the centrifugal force and the force attributable to Marangoni convection, act upon the deionized water adhering to the surface of the substrate. However, it is difficult to control the balance between the two types of force during Rotagoni drying, which virtually makes it impossible to control the gas-liquid-solid interface. It is therefore impossible to move the gas-liquid-solid interface in one direction (toward outside along the radial direction) at an even speed, thereby wetting the dried substrate surface region again and generating drying defects such as a water mark in some cases.

On the other hand, according to the drying method described in JP-A-10-321587, although the inconvenience above associated with rotations of a substrate will not occur, the following problem may arise. That is, after the partition plate scrapes off and removes water droplets adhering to the surface of the substrate, water droplets remaining on the surface of the substrate are sent to the location of the drainage block. Hence, the droplets adhering to the surface of the substrate after rinsing will stay on the substrate until they have moved passed the partition plate and the drainage block and been removed. As a result, eluting materials from the substrate get mixed with the droplets remaining on the substrate, thereby generating drying defects and consequently causing problems such a degraded product quality, a lowered yield.

The invention has been made in light of the problems above, and accordingly, an object of the invention is to provide a substrate processing apparatus for and a substrate processing method of favorably drying a surface of a substrate during drying of the surface of the substrate which is wet with a liquid while preventing destruction of patterns formed on the surface of the substrate.

According to a first aspect of the present invention, there is provided a substrate processing apparatus which dries a surface of a substrate which is wet with a liquid, the apparatus comprising: a proximity member which includes an opposed surface disposed facing the surface of the substrate but away from the surface of the substrate, and which is structured to move freely and relatively to the substrate in a predetermined moving direction in a condition that a space between the opposed surface and the surface of the substrate is filled with the liquid to form a liquid-tight layer; a driver which moves the proximity member relatively to the substrate in the moving direction; a solvent gas supplier which supplies a solvent gas toward an end portion of the liquid-tight layer on the upstream-side in the moving direction, the solvent gas necessarily containing a solvent component which is dissolved in the liquid and reduces the surface tension; and a liquid supplier which supplies the liquid toward the surface of the substrate at an upstream-side interface of the liquid-tight layer or on the downstream-side in the moving direction relative to the upstream-side interface, thereby replacing the liquid staying on the surface of the substrate with thus supplied liquid.

According to a second aspect of the present invention, there is provided a substrate processing method of drying a surface of a substrate which is wet with a liquid, the method comprising the steps of: arranging a proximity member which includes an opposed surface which faces the surface of the substrate, in such a manner that the opposed surface is spaced apart from the surface of the substrate, filling up a space between the opposed surface and the surface of the substrate with the liquid and accordingly forming a liquid-tight layer; moving the proximity member in a predetermined moving direction relative to the substrate while maintaining the condition that the liquid-tight layer is formed; supplying a solvent gas toward an end portion of the liquid-tight layer on the upstream side in the moving direction, the solvent gas necessarily containing a solvent component which is dissolved in the liquid and reduces the surface tension; and supplying the liquid toward the surface of the substrate at an upstream-side interface of the liquid-tight layer or on the downstream side in the moving direction relative to the upstream-side interface, thereby replacing the liquid contacting the surface of the substrate with thus supplied liquid.

In the structure according to the invention, in a condition that the liquid-tight layer is formed with the liquid filling up the space between the substrate surface and the opposed surface which is spaced apart from the substrate surface, the proximity member moves in the predetermined moving direction relative to the substrate, while the solvent gas, necessarily containing the solvent component which is dissolved in the liquid and reduces the surface tension, is supplied toward the end portion of the liquid-tight layer on the upstream side in the moving direction. This permits the proximity member control the location of the upstream-side interface while Marangoni convection are produced at the upstream-side interface, and therefore, the upstream-side interface moves toward the downstream side and the substrate surface region corresponding to thus moving interface dries. Further, the liquid is supplied toward the substrate surface at the upstream-side interface of the liquid-light layer or on the downstream side in the moving direction relative to the upstream-side interface, thereby replacing the liquid contacting the substrate surface with the additionally supplied fresh liquid. Hence, during drying, it is possible to suppress the amount of the eluting materials contained in the liquid which is on the substrate surface and prevent generation of a watermark. Further, even when a substrate surface region includes fine patterns, the effectively lowered surface tension at the upstream-side interface effectively prevents destruction of the patterns.

In addition, the solvent gas used in the invention is preferably a gas containing IPA vapor (isopropyl alcohol) as the solvent component, considering the safety, the price, etc. Alternatively, as the solvent component, vapors of various types of solvents such as ethyl alcohol and methyl alcohol may be used. Further, while the solvent gas may be vapor of such a solvent itself, for the purpose of sending the solvent component to the substrate surface, the solvent gas may be a mixture of an inert gas and the solvent component obtained using an inert gas such as a nitrogen gas as a carrier.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a drawing of a substrate processing apparatus according to a first embodiment of the invention;

FIG. 2A is a partial side view of the substrate processing apparatus shown in FIG. 1;

FIG. 2B is a plan view of the substrate processing apparatus shown in FIG. 2A;

FIG. 3 is a perspective view of a proximity block;

FIG. 4 is a drawing which shows an example of the structure of a solvent gas supply unit;

FIGS. 5A through 5D are schematic drawings which show operations of the substrate processing apparatus shown in FIG. 1;

FIGS. 6A and 6B are drawings which show drying realized by movement of the proximity block;

FIG. 7A is a partial side view of a substrate processing apparatus according to a second embodiment of the invention;

FIG. 7B is a plan view of the substrate processing apparatus shown in FIG. 7A;

FIG. 8 is a drawing of a substrate processing apparatus according to a third embodiment of the invention;

FIG. 9 is a drawing of a substrate processing apparatus according to a fourth embodiment of the invention;

FIG. 10 is a drawing of a substrate processing apparatus according to a fifth embodiment of the invention;

FIG. 11 is a side view of a substrate processing apparatus according to other embodiment of the invention;

FIG. 12 is a perspective view of a substrate processing apparatus according to another embodiment of the invention; and

FIG. 13 is a plan view of a substrate processing apparatus according to still other embodiment of the invention.

### DETAILED DESCRIPTION OF THE PREFERRED EMBODIMENTS

### First Embodiment

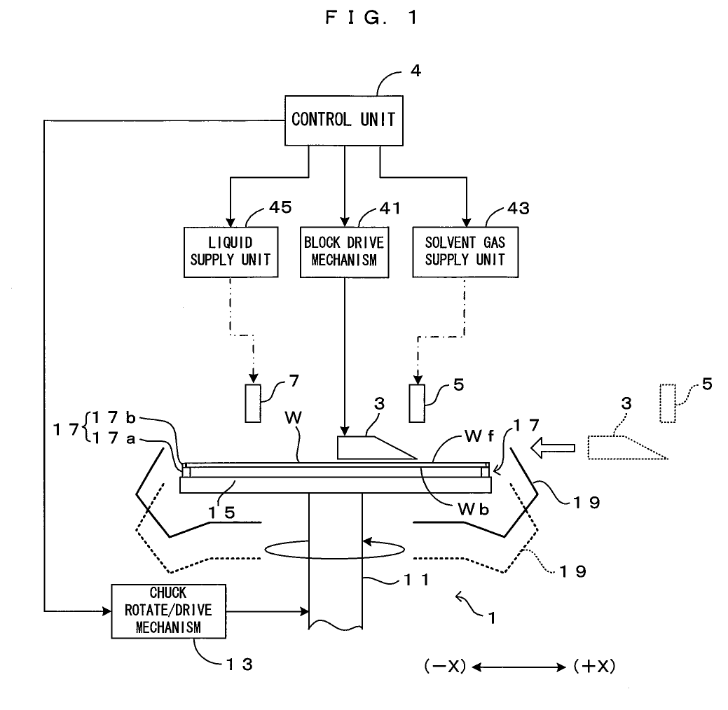

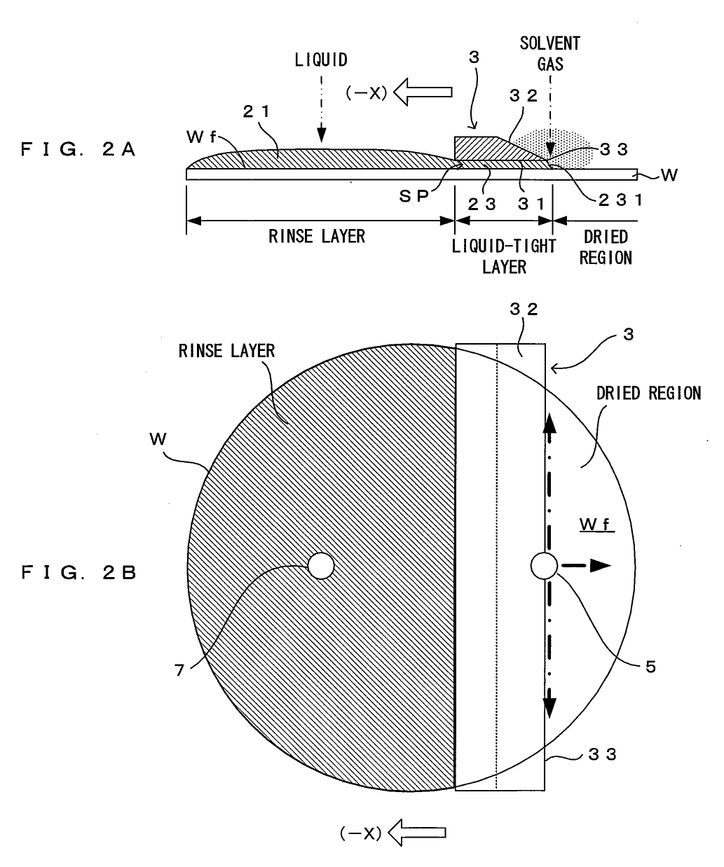

FIG. 1 is a drawing of the substrate processing apparatus according to the first embodiment of the invention. FIGS. 2A and 2B are partially enlarged views of the substrate processing apparatus shown in FIG. 1. To be more precise, FIG. 2A is a partial side view of the substrate processing apparatus, while FIG. 2B is a plan view of the substrate processing apparatus shown in FIG. 2A. This substrate processing apparatus is a substrate processing apparatus of the single-wafer type which is used for cleaning process to remove contaminants adhering to the front surface Wf of a substrate W which may be a semiconductor wafer. Describing this in more detail, this is an apparatus which dries a rinsed substrate W after chemical processing with a chemical solution and rinsing with a rinsing liquid, such as pure water and DIW (deionized water) of the front surface Wf of the substrate W on which patterns are formed. In this substrate processing apparatus, an eventually rinsed substrate W seats a puddle-like rinse layer which is the rinsing liquid adhering to the entire front surface Wf of the substrate, and drying is executed from this state.

This substrate processing apparatus comprises a spin chuck 1 which holds a substrate W horizontally such that the front surface Wf of the substrate W is directed toward above and rotates the substrate W, a proximity block 3 which is disposed facing the substrate W which is held by the spin chuck but away from the substrate W, a solvent gas nozzle 5 which discharges a solvent gas from above the substrate W and a liquid nozzle 7 which discharges a liquid consisting of the same component as that of a rinsing liquid toward the front surface Wf of the substrate.

A rotation column 11 of the spin chuck 1 is linked to a rotation shaft of a chuck rotate/drive mechanism 13 which contains a motor, and rotates about a vertical axis when driven by the chuck rotate/drive mechanism 13. A disk-shaped spin base 15 is linked by a fastening component such as a screw to a top end portion of the rotation column 11 as one integrated unit. The spin base 15 therefore rotates about the vertical axis when driven by the chuck rotate/drive mechanism 13 in response to an operation command received from a control unit 4 which controls the apparatus as a whole.

Plural chuck pins 17 for holding the substrate W at the rim are disposed upright in the vicinity of the rim of the spin base 15. There may be three or more chuck pins 17 to securely hold the disk-shaped substrate W, and the chuck pins are arranged at equal angular intervals along the rim of the spin base 15. Each chuck pin 17 comprises a substrate support part 17a which supports the substrate W at the rim from below and a substrate holding part 17b which presses the substrate W at the outer peripheral edge surface and holds the substrate W. Each chuck pin 17 is formed so as to be capable of switching between a pressing state that the substrate holding part 17b presses the substrate W at the outer peripheral edge surface and a released state that the substrate holding part 17b stays away from the outer peripheral edge surface of the substrate W.

The plural chuck pins 17 are in the released state while the substrate W is being transferred to the spin base 15 but in the pressing state for cleaning of the substrate W. When in the pressing state, the plural chuck pins 17 hold the substrate W at the rim and keep the substrate approximately horizontally over a predetermined gap from the spin base 15. The substrate W is held with its front surface (pattern formation surface) Wf directed toward above and its back surface Wb toward below.

For prevention of splashing of a chemical solution and a rinsing liquid around the substrate W during execution of chemical processing and rinsing of the substrate, a splashing preventing cup 19 is disposed around the spin base 15. In response to a control signal from the control unit 4, the splashing preventing cup 19 is driven to retract to a lower position (the position denoted at the dotted line in FIG. 1), which is below an upper position (the position denoted at the solid line in FIG. 1) at which the splashing preventing cup 19 can collect the chemical solution and the rinsing liquid, to avoid interfering with a substrate transporter (not shown) and the proximity block 3 while the substrate transporter is handing the substrate W to the spin base 15 and during drying of the front surface Wf of the substrate by the proximity block 3 in a manner described later.

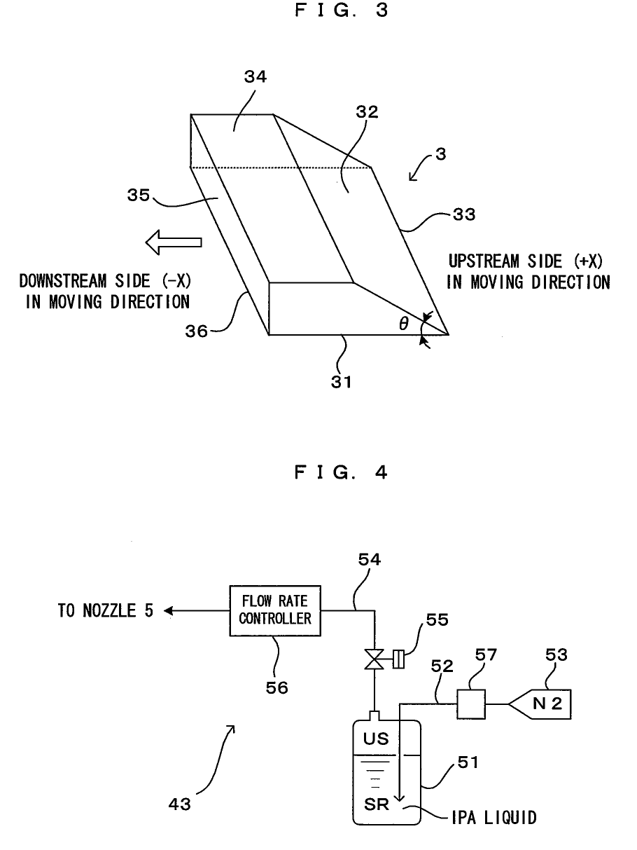

FIG. 3 is a perspective view of the proximity block. The proximity block 3 is a right prism member which serves as the “proximity member” of the invention and is shaped approximately like a trapezoid in vertical cross section, and one side surface of the proximity block is an opposed surface 31 which faces the front surface Wf of the substrate wet with the rinsing liquid. The proximity block 3 is disposed so as to freely move horizontally, and a block drive mechanism 41 is linked to the top and the bottom side portions of the proximity block 3 in FIG. 3. Hence, as the block drive mechanism 41 operates in response to an operation command received from the control unit 4, the proximity block 3 reciprocally moves along the horizontal direction X at a predetermined speed. Specifically, as the block drive mechanism 41 operates, the proximity block 3 moves in the horizontal direction X from a retract position (the position denoted at the dotted line in FIG. 1), which is off to the side of the substrate W, thereby achieving drying described later of the entire surface of the substrate while the proximity block 3 closely facing the front surface Wf of the substrate.

In this embodiment, drying is performed with the proximity block 3 moving to the left-hand side (−X) in FIG. 3 in the horizontal direction X. This horizontal direction (−X) corresponds to the “predetermined moving direction” of the invention, and the horizontal direction (−X) will be hereinafter referred to simply as the “moving direction”. The block drive mechanism 41 may be a known mechanism, such as a feed screw mechanism, which moves the proximity block 3 along a guide and a ball screw elongating in the horizontal direction X as a motor drives. In this embodiment, the block drive mechanism 41 thus functions as the “driver” of the invention.

Other side surface 32 of the proximity block 3 is a surface which is located on the upstream side (+X) in the moving direction and directed toward above. To be more precise, the side surface 32 is connected with an upstream side portion 33 which is one of side portions defining the opposed surface 31 and which is located on the upstream side (+X) in the moving direction among the side portions, and the side surface 32 extends from this connection position in a direction away from the substrate surface Wf overlooking the upstream side (+X) in the moving direction. The side surface 32 corresponds to the “extending surface” of the invention. The upstream side portion 33 elongates to the orthogonal direction (the up-down direction in FIG. 2B which will be hereinafter referred to as the “width direction”) to the moving direction, and its length along the width direction, namely, the length of the proximity block 3 taken along the width direction is approximately the same as the diameter of the substrate or longer, so that as the proximity block 3 moves in the moving direction, the entire front surface of the substrate can be processed. Meanwhile, at the upstream-side end portion of the proximity block 3, the opposed surface 31 and the side surface 32 (extending surface) are at an acute angle θ.

The proximity block 3 is arranged such that the opposed surface 31 is slightly spaced apart from the front surface Wf of the substrate and does not interfere with the substrate holding parts 17b of the chuck pins 17, and therefore, a part of the rinsing liquid which forms the rinse layer 21 adhering as a puddle to the front surface Wf of the substrate entirely fills up the space SP between the opposed surface 31 and the front surface Wf of the substrate due to the capillary phenomenon and a liquid-tight layer 23 is formed. Such a proximity block 3 preferably is made of quartz, noting that (1) the material is hydrophilic, (2) the material must be clean, (3) the material must be easily processed, and so on.

Disposed above the upstream side end portion of the proximity block 3 is the solvent gas nozzle 5 which supplies the solvent gas toward an end portion of the liquid-tight layer 23 on the upstream side (+X) in the moving direction, i.e., the upstream-side edge 231. The solvent gas nozzle 5 is connected with a solvent gas supply unit 43, and as the solvent gas supply unit 43 operates in response to an operation command received from the control unit 4, the solvent gas is pressure-fed to the solvent gas nozzle 5. Used as the solvent gas is a mixture of a solvent component and an inert gas such as a nitrogen gas. The solvent component gets dissolved in the rinsing liquid (whose surface tension is 72 dyn/cm when the rinsing liquid is deionized water) and reduces the surface tension. For example, IPA (isopropyl alcohol) vapor (whose surface tension is 21 through 23 dyn/cm) is used as the solvent component. The solvent component is not limited to IPA vapor instead, vapors of various types of solvents such as ethyl alcohol and methyl alcohol may be used. In essence, any solvent component which is dissolved in the rinsing liquid and reduces the surface tension may be used. In this embodiment, the solvent gas nozzle 5 and the solvent gas supply unit 43 function as the “solvent gas supplier” of the invention.

The solvent gas can be diffused all along the width direction and supplied to the same to the entire upstream-side edge 231 of the liquid-tight layer 23 using by even one such solvent gas nozzle 5, while the solvent gas can be supplied evenly to the entire upstream-side edge 231 of the liquid-tight layer 23 using by multiple nozzles disposed along the width direction or a nozzle having plural discharge outlets along the width direction.

While even one such solvent gas nozzle 5 can diffuse the solvent gas all along the width direction and supply to the same to the entire upstream-side edge 231 of the liquid-tight layer 23, multiple nozzles disposed along the width direction or a nozzle having plural discharge outlets along the width direction supply the solvent gas evenly to the entire upstream-side edge 231 of the liquid-tight layer 23.

FIG. 4 is a drawing which shows an example of the structure of the solvent gas supply unit. The solvent gas supply unit 43 comprises a solvent tank 51 which holds an IPA liquid as the solvent component, and an occupied reservoir area SR of the reservoir space inside the solvent tank 51 holding the IPA liquid is linked to a nitrogen gas supply part 53 via a pipe 52. Further, an empty reservoir area US of the reservoir space inside the solvent tank 51 not holding the IPA liquid is linked to the solvent gas nozzle 5 via a pipe 54. Hence, as the nitrogen gas supply part 53 pressure-feeds a nitrogen gas to the solvent tank 51, the IPA liquid bubbles up and IPA gets dissolved in the nitrogen gas, whereby the solvent gas (nitrogen gas+IPA vapor) is formed and appears in the empty reservoir area US. An on-off valve 55 and a solvent gas flow rate controller 56 are inserted in the pipe 54, and as the nitrogen gas supply part 53, the on-off valve 55 and the flow rate controller 56 operate under the control of the control unit so that it is possible to control supply and discontinuation of supply of the solvent gas to the solvent gas nozzle 5. Further, in order to increase the concentration of the IPA vapor in the solvent gas, a temperature adjuster 57 may be inserted in the pipe 52 and the temperature of the nitrogen gas may be increased. This efficiently reduces the surface tension at the upstream-side edge 231 of the liquid-tight layer 23 and facilitates drying. Temperature adjustment of the nitrogen gas may be replaced with temperature adjustment of the IPA liquid which is held inside the solvent tank 51. Temperature adjustment of the solvent gas itself to warm up the solvent gas appearing in the empty reservoir area US is not preferable as this facilitates elution of eluting materials into the rinsing liquid from the front surface Wf of the substrate.

The solvent gas nozzle 5 is structured so as to move in the moving direction in synchronization to the proximity block 3. That is, a link mechanism (not shown) links the solvent gas nozzle 5 with the proximity block 3, and as the block drive mechanism 41 operates, the proximity block 3 and the solvent gas nozzle 5 move as one integrated unit in the moving direction. This ensures that the gap between the proximity block 3 and the discharging position of the solvent gas remains over a predetermined distance while the proximity block 3 moves. As a result, the physical properties (the velocity of flow, the flow volume, etc.) of the solvent gas blown against the upstream-side edge 231 of the liquid-tight layer 23 become stable, which in turn realizes stable drying. While an independent driver may be disposed to the solvent gas nozzle 5 so that the solvent gas nozzle 5 moves in concert with the proximity block 3, the drive structure can be simple when the single driver moves the solvent gas nozzle 5 and the proximity block 3 as one integrated unit.

There is one or multiple liquid nozzle 7 for supply of the liquid, which functions as the “first nozzle” of the invention, disposed at the upper position above the substrate W on the downstream side in the moving direction relative to the proximity block 3. A liquid supply unit 45 is connected with the liquid nozzle 7, and as the liquid supply unit 45 operates in response to an operation command received from the control unit 4, the liquid consisting of the same component as that of the rinsing liquid adhering to the substrate W is pressure-fed to the liquid nozzle 7. In this manner, from the liquid nozzle 7, the liquid is supplied to the rinse layer 21 contacting the front surface Wf of the substrate and further to the liquid-tight layer 23 from the rinse layer 21. This ejects the rinsing liquid adhering to the front surface Wf of the substrate off from the substrate W, and replaces the rinsing liquid contacting the front surface Wf of the substrate on the downstream side in the moving direction to the upstream-side interface of the liquid-tight layer 23 with the liquid additionally supplied from the liquid nozzle 7. In this embodiment, the liquid nozzle 7 and the liquid supply unit 45 thus function as the “liquid supplier” of the invention.

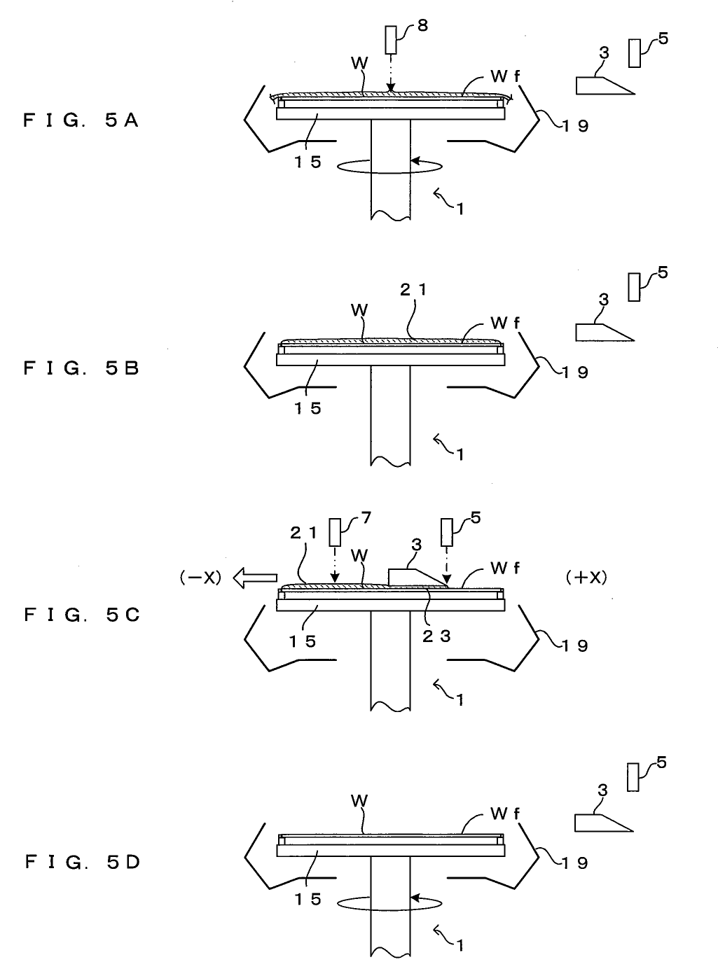

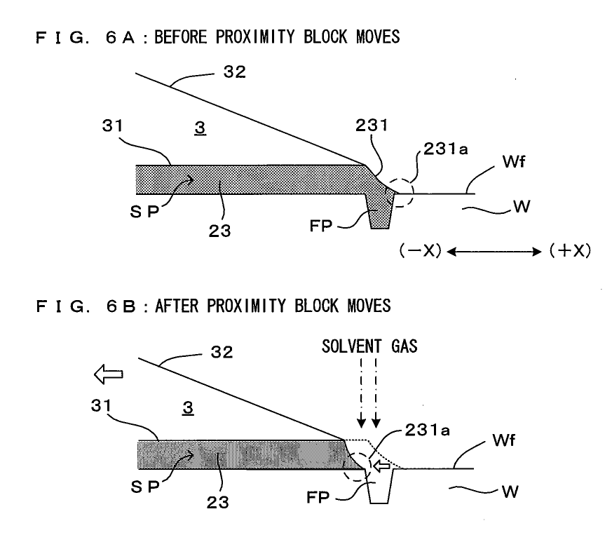

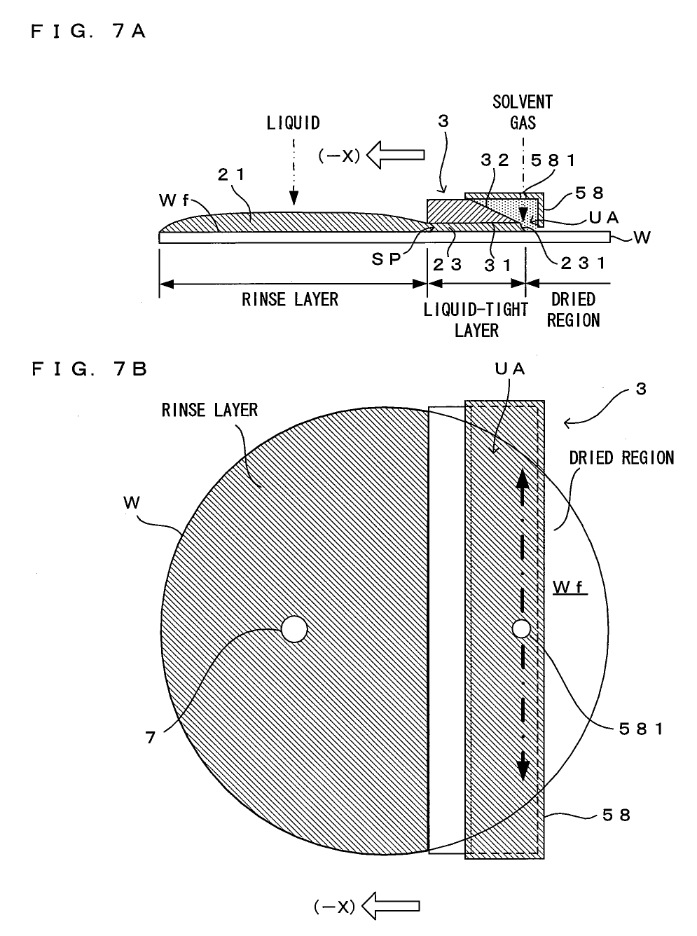

The drying operation of the substrate processing apparatus having the structure above will now be described with reference to FIGS. 5A through 5D and 6A and 6B. FIGS. 5A through 5D are schematic drawings which show operations of the substrate processing apparatus shown in FIG. 1. FIGS. 6A and 6B are drawings which show drying realized by movement of the proximity block. Upon loading of the unprocessed substrate W into inside the apparatus by the substrate transporter (not shown), the control unit 4 aligns the splashing preventing cup 19 to the upper position (the position denoted at the solid line in FIG. 1) around the spin base 15, and executes cleaning (chemical processing+rinsing+drying) of the substrate W. First, after the chemical solution is supplied to the substrate W and predetermined chemical processing is carried out, rinsing of the substrate W is executed. For details, as shown in FIG. 5A, the rinsing liquid is fed to the front surface Wf of the substrate from a rinse nozzle 8, and as the substrate W rotates by driving the chuck rotate/drive mechanism 13, the centrifugal force spreads the rinsing liquid and the entire front surface Wf of the substrate is rinsed.

Upon rinsing for a predetermined period of time, the substrate W stops rotating. The entire front surface Wf of the substrate thus rinsed seats the swollen rinsing liquid, thereby forming the rinse layer 21 which is shaped like a puddle (FIG. 5B). The rinse nozzle 8 may discharge the rinsing liquid again after rinsing to thereby form the puddle-like rinse layer 21 on the front surface Wf of the substrate.

The control unit 4 then moves down the splashing preventing cup 19 to the lower position (the position denoted at the dotted line in FIG. 1), thereby making the spin base 15 projecting above the splashing preventing cup 19, and performs drying of the front surface Wf of the substrate. That is, as shown in FIG. 5C, as the block drive mechanism 41 operates, the proximity block 3 moves at a constant velocity in the moving direction (−X), and as the solvent gas supply unit 43 operates, the solvent gas is discharged from the solvent gas nozzle 5. Meanwhile, The liquid is supplied to the rinse layer 21 from the liquid nozzle 7. In this embodiment, since the liquid consists of the same component as that of the rinsing liquid, the rinsing liquid (the liquid) may be supplied from the rinse nozzle 8.

The liquid-tight layer 23 is formed as the rinsing liquid (the liquid) fills up the space SP between the opposed surface 31 and the front surface Wf of the substrate, and therefore, as the proximity block 3 moves in the moving direction (−X) from the state shown in FIG. 6A to the state shown in FIG. 6B, the upstream-side edge 231 of the liquid-tight layer 23 goes off from the proximity block 3 and gets exposed. At this stage, the solvent gas supplied toward the upstream-side edge 231 of the liquid-tight layer gets dissolved in the liquid which forms the liquid-tight layer 23, the surface tension at the upstream-side interface 231a (gas-liquid-solid interface) of the liquid-tight layer 23 decreases, and Marangoni convection are produced. This pulls the liquid which forms the liquid-tight layer 23 toward the downstream side (−X) in the moving direction, moves the upstream-side interface 231a as well toward the downstream side, and dries the substrate surface region corresponding to thus moving interface.

While the dried region spreads toward the downstream side (−X) in the moving direction as the upstream-side interface 231a moves as described above, on the downstream side in the moving direction relative to the upstream-side interface 231a, the rinsing liquid (the liquid) remains in contact with the front surface of the substrate until the entire front surface Wf of the substrate has dried up. Although the amount of eluting materials eluting into the liquid from the substrate W therefore increases approximately proportionally to the staying time of the liquid on the front surface Wf of the substrate, supply of the liquid to the rinse layer 21 from the liquid nozzle 7 ejects the liquid remaining stagnant on the front surface Wf of the substrate off from the substrate W. In other words, the liquid supplied from the liquid nozzle 7 pushes away such a liquid remaining on the front surface Wf of the substrate together with the eluting materials, and such a liquid and the eluting materials are discharged to outside the substrate at the rims of the rinse layer 21 and the liquid-tight layer 23 exclusive of the upstream-side interface 231a. The liquid contacting the front surface Wf of the substrate is thus replaced with the additionally supplied fresh liquid, at the upstream-side interface 231a or on the downstream side (−X) in the moving direction relative to interface 231a. In consequence, even though a part of the substrate W elutes into the liquid, this liquid is ejected off from the front surface Wf of the substrate due to the replacing action described above. Further, the additionally supplied liquid quickens flows of the liquid generated between the proximity block 3 and the substrate W owing to the capillary phenomenon, which facilitates ejection of the eluting materials off from the substrate W.

As the proximity block 3 and the solvent gas nozzle 5 move in the moving direction (−X) while the fresh liquid supplied from the liquid nozzle 7 replaces the liquid contacting the front surface Wf of the substrate. the substrate surface region which dries, namely, the dried region spreads. It is thus possible to dry the entire front surface Wf of the substrate as the proximity block 3 and the solvent gas nozzle 5 scan all over the substrate.

As drying of the front surface Wf of the substrate completes, drying of the back surface Wb is executed to remove the liquid component adhering to the back surface Wb of the substrate off from the substrate W,. That is, as shown in FIG. 5D, the control unit 4 moves the splashing preventing cup 19 to the upper position, makes the chuck rotate/drive mechanism 13 drive the substrate W into rotations, whereby the back surface Wb is drained off of the liquid component adhering thereto (i.e., execution of spin drying). Following this, the control unit 4 moves the splashing preventing cup 19 to the lower position, thereby making the spin base 15 projecting above the splashing preventing cup 19. In this state, the substrate transporter unloads thus processed substrate W out from the apparatus, which completes a series of cleaning of one substrate W.

As described above, this embodiment requires that the proximity block 3 moves in the moving direction with the proximity block 3 positioned in the vicinity of the front surface Wf of the substrate and the liquid-tight layer 23 formed, and that the solvent gas containing the solvent component, which is dissolved in the liquid forming the liquid-tight layer 23 and which reduces the surface tension, is supplied toward the upstream-side edge 231 of the liquid-tight layer 23. As Marangoni convection are produced at the upstream-side edge 231 and the upstream-side interface 231a accordingly moves toward the downstream side while accordingly controlling the location of the upstream-side interface 231a (gas-liquid-solid interface), the substrate surface region dries. It is thus possible to dry the substrate surface region utilizing the Marangoni effect while the proximity block 3 prevents the upstream-side interface 231a from getting disturbed, and hence, prevent generation of drying defects such as water marks in this substrate surface region.

The embodiment above further requires that the liquid nozzle 7 supplies the liquid to the rinse layer 21 until the entire front surface Wf of the substrate has dried up, to thereby replace the liquid contacting the front surface Wf of the substrate on the downstream side (−X) in the moving direction relative to the upstream-side interface 231 a with the additionally supplied fresh liquid. Hence, even despite elution of a part of the substrate into the liquid, this liquid is ejected off from the front surface Wf of the substrate due to the replacing action described above, which makes it possible to suppress the amount of eluting materials contained in the liquid which is on the front surface Wf of the substrate while drying process is executed. As a result, generation of a water mark is prevented without fail and the front surface Wf of the substrate is dried in a favorable fashion.

Further, even when fine patterns FP are formed in the substrate surface region as shown in FIG. 6, since the front surface Wf of the substrate is dried utilizing the Marangoni effect while controlling the location of the upstream-side interface 231a (gas-liquid-solid interface), the upstream-side interface 231a will not move back and forth in the moving direction and the liquid forming the liquid-tight layer 23 will therefore not impose any load upon the fine patterns FP, thereby making it possible to dry the front surface Wf of the substrate while effectively preventing destruction of the patterns. In addition, since the front surface Wf of the substrate is dried without rotating the substrate W, the centrifugal force attributed to the rotations of the substrate W will not destroy the patterns. Moreover, the solvent component is dissolved even in the liquid which is present in the gaps between the fine patterns FP and the surface tension of this liquid is accordingly lowered, thereby decreasing the negative pressure developing in the gaps between the patterns and effectively preventing destruction of the patterns.

### Second Embodiment

FIGS. 7A and 7B are drawings of a substrate processing apparatus according to the second embodiment of the invention. To be more precise, FIG. 7A is a partial side view of the substrate processing apparatus and FIG. 7B is a plan view of the substrate processing apparatus shown in FIG. 7A. A major difference of the substrate processing apparatus according to the second embodiment from the first embodiment is that a cover member 58 is attached to the proximity block 3. The structures and the operations are otherwise basically similar to those according to the first embodiment, and therefore, they will be denoted at the same reference symbols but will not described in redundancy.

In this embodiment, on the upstream side (+X) in the moving direction to the proximity block 3, the cover member 58 is attached to the proximity block 3 such that the cover member 58 entirely covers the upstream-side edge 231 of the liquid-tight layer 23. An upstream-side atmosphere UA located on the upstream side (+X) to the liquid-tight layer 23 is therefore surrounded by the cover member 58. The top surface of the cover member 58 has one gas supply hole 581 or plural gas supply holes 581 along the width direction, and via the gas supply hole 581, the solvent gas supply unit 43 is linked to the upstream-side atmosphere UA which is surrounded by the cover member 58. Operating in response to an operation command received from the control unit 4, the solvent gas supply unit 43 supplies the solvent gas to the upstream-side atmosphere UA. The cover member 58 therefore traps the solvent gas, whereby the concentration of the solvent gas in the upstream-side atmosphere UA remains high. This facilitates reduction of the surface tension at the upstream-side edge 231 of the liquid-tight layer 23 and enhances the effect of preventing pattern destruction. Further, the cover member 58 has the same length taken along the moving direction all across the width direction. It is therefore possible to ensure a space whose length taken along the moving direction is uniform in the width direction (longitudinal direction) inside the cover member 58 and to keep the concentration of the solvent gas uniform in the width direction. Hence, it is possible to dry the front surface Wf of the substrate uniformly in the width direction.

### Third Embodiment

FIG. 8 is a drawing of a substrate processing apparatus according to the third embodiment of the invention. A major difference of the substrate processing apparatus according to the third embodiment from the second embodiment is that the liquid is supplied to the top surface 34 of the proximity block 3 instead of supplying the liquid directly to the rinse layer 21 which is in contact with the front surface Wf of the substrate. Describing this in more detail, there is one liquid nozzle 71 for liquid supply which functions as the “second nozzle” of the invention or plural such liquid nozzles 71 along the width direction, at the upper position above the proximity block 3. The liquid supply unit 45 is connected with the liquid nozzle 71, and as the proximity block 3 moves, the liquid supply unit 45 pressure-feeds the liquid consisting of the same component as that of the rinsing liquid adhering to the substrate W into the liquid nozzle 71 and the liquid is discharged from the liquid nozzle 71 toward the top surface 34 of the proximity block 3. Due to this, as the upstream-side interface 231a of the liquid-tight layer 23 moves, the liquid is supplied to the top surface 34 of the proximity block 3. The structures and the operations are otherwise basically similar to those according to the second embodiment, and therefore, they will be denoted at the same reference symbols but will not described in redundancy.

The liquid supplied to the top surface 34 of the proximity block 3 flows down toward the upstream side portion 33 along the side surface 32 (extending surface) from the top surface 34, while flowing down toward a downstream side portion 36 which is one of side portions defining the opposed surface 31 and which is located on the downstream side (−X) in the moving direction, along a side surface 35 overlooking the downstream side of the proximity block 3 from the top surface 34. The liquid flowing down toward the upstream side portion 33 is supplied to the upstream-side interface 231a of the liquid-tight layer 23, while the liquid flowing down toward the downstream side portion 36 is supplied to a boundary portion between the rinse layer 21 and the liquid-tight layer 23. In consequence, the additionally supplied fresh liquid replaces the liquid contacting the front surface Wf of the substrate at the upstream-side interface 231a or on the downstream side (−X) in the moving direction relative to the upstream-side interface 231a. As in the embodiment described above therefore, it is possible to prevent the rinsing liquid (the liquid) contacting the substrate W from staying stagnant and to favorably dry the front surface Wf of the substrate. In this embodiment, the side surfaces 32, 34 and 35 thus function as the “non-opposed surface” of the invention.

Further, according to this embodiment, while the liquid discharged from the liquid nozzle 71 flows down toward the upstream side portion 33 along the side surface 32, it is possible to dissolve the solvent gas in this liquid. This efficiently sends the liquid whose surface tension has decreased toward the rinsing liquid (the liquid) contacting the front surface Wf of the substrate at the upstream-side interface 231a of the liquid-tight layer 23. It is therefore possible to effectively lower the surface tension at the upstream-side interface 231a, efficiently produce Marangoni convection, and enhance the efficiency of drying the front surface Wf of the substrate. Further, this embodiment, requiring that the opposed surface 31 and the side surface 32 (extending surface) are at an acute angle, permits the liquid to gradually flow down to the upstream-side interface 231a of the liquid-tight layer 23 via the side surface 32 (extending surface), and hence, securely achieves dissolution of the solvent gas in the liquid while this liquid flows down the side surface 32. As a result, the efficiency of drying of the front surface Wf of the substrate further improves.

Further, this embodiment attains the following excellent effect. That is, since the liquid is supplied toward the front surface Wf of the substrate via the proximity block 3, i.e., since the liquid is supplied toward the front surface Wf of the substrate along the side surfaces 32, 34 and 35 of the proximity block 3, the proximity block 3 rectifies the liquid discharged from the liquid nozzle 71 and guides the liquid to the front surface Wf of the substrate. As compared with where the liquid is supplied directly to the front surface Wf of the substrate therefore, it is possible to supply the liquid as uniform flows to the front surface Wf of the substrate and suppress generation of residual water droplets on the front surface Wf of the substrate due to splashing of the liquid or the like.

Further, since the liquid discharged from the liquid nozzle 71 is guided to the upstream side portion 33, the fresh liquid is supplied directly to the upstream-side interface 231a of the liquid-tight layer 23. This enhances the efficiency of replacement of the liquid at the upstream-side interface 231a, thereby even more effectively preventing generation of watermarks. That is, one of the causes of a water mark is believed to be deposition, into the rinsing liquid (the liquid) contacting the front surface Wf of the substrate, of eluting materials eluting from the substrate W during drying the substrate surface region corresponding to the upstream-side interface 231a. Hence, if the eluting materials are discharged to outside the substrate the upstream-side interface 231a, generation of a watermark can be prevented most efficiently. This embodiment therefore requires supplying fresh liquid directly to the upstream-side interface 231 a, thereby replacing the liquid staying on the front surface Wf of the substrate with fresh liquid at the upstream-side interface 231a. It is thus possible to suppress the amount of eluting materials contained in the liquid which is on the front surface of the substrate during drying the substrate surface region corresponding to the upstream-side interface 231a, and hence, effectively prevent generation of a watermark.

Further, for prevention of drying defects on the front surface Wf of the substrate, it is desirable that the drying speed, namely, a velocity at which the upstream-side interface 231a of the liquid-tight layer 23 moves is constant. This embodiment is very effective in ensuring that the drying speed remains constant. In particular, according to this embodiment, as the liquid is supplied to the upstream-side interface 231a of the liquid-tight layer 23, it is possible to suppress a change of the solvent component concentration in the solution which is the liquid in which the solvent component has been dissolved (i.e., the liquid+the solvent component) at the upstream-side interface 231a. This attains an approximately constant decrease of the surface tension at the upstream-side interface 231a and maintains a velocity at which the upstream-side interface 231a (gas/liquid/solid interface) moves due to Marangoni convection. As the moving velocity of the upstream-side interface 231a is thus constant, it is possible to uniformly dry the front surface Wf of the substrate while preventing water droplets from staying on the front surface Wf of the substrate.

Further, since supply of the liquid to the upstream-side interface 231a of the liquid-tight layer 23 means supply of the liquid to a region adjacent to the dried region, the amount of the liquid supplied to the upstream-side interface 231a must be very small. In this regard, since the structure according to this embodiment permits a part of the liquid from the liquid nozzle 71 guided to the upstream side portion 33 but the remainder guided to the downstream side portion 36, it is possible to improve the controllability of the flow rate of the liquid discharged from the liquid nozzle 71.

### Fourth Embodiment

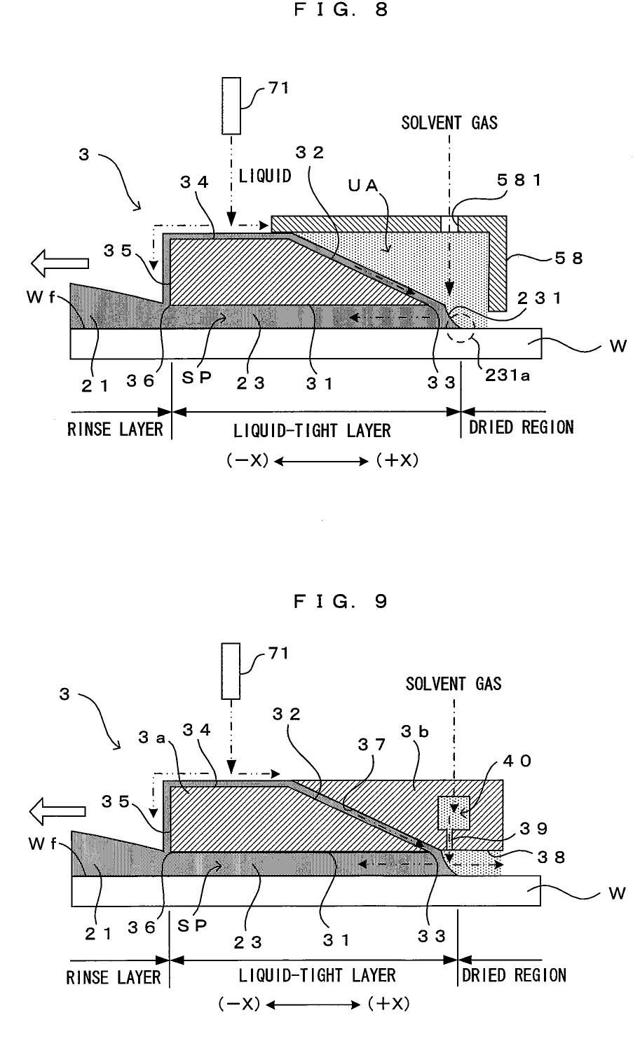

FIG. 9 is a drawing of a substrate processing apparatus according to the fourth embodiment of the invention. A major difference of the substrate processing apparatus according to the fourth embodiment from the third embodiment is addition of a structure for guiding the liquid discharged from the liquid nozzle 71 to the upstream side portion 33 while maintaining the liquid discharged from the liquid nozzle 71 liquid-tight on the side surface 32 and addition of a structure for preventing the solvent gas from staying stagnant. The structures and the operations are otherwise basically similar to those according to the third embodiment, and therefore, they will be denoted at the same reference symbols but will not described in redundancy.

In this embodiment, the proximity block 3 comprises a main section 3a which is utilized in the embodiment described above and which forms the liquid-tight layer 23 in the space SP formed between the opposed surface 31 and the front surface Wf of the substrate, and an opposed section 3b which is disposed facing the main section 3a on the upstream side (+X) in the moving direction relative to the main section 3a. The opposed section 3b is a right prism member shaped approximately like a trapezoid in vertical cross section like the main section 3, and its one side surface is a guide surface 37 which faces the side surface (extending surface) 32 of the main section 3a and guides the liquid discharged from the liquid nozzle 71 to the upstream side portion 33. The liquid discharged from the liquid nozzle 71 then flows from the top surface 34 toward the upstream side portion 33 while attaining a liquid-tight state between the side surface (extending surface) 32 and the guide surface 37. Since this permits the liquid to flow to the upstream-side interface 231a of the liquid-tight layer 23 while trapping the liquid between the side surface 32 and the guide surface 37, it is possible to ensure that the liquid flows uniformly even though the amount of the liquid guided to the upstream side portion 33 is very small. Hence, it is possible to supply a constant amount of the liquid to the upstream-side interface 231a and control a velocity at which the upstream-side interface 231a (gas/liquid/solid interface) moves due to Marangoni convection to a constant velocity. This is very effective in uniformly drying the front surface Wf of the substrate.

The bottom surface 38 of the opposed section 3b (which corresponds to the “upstream-side opposed section” of the invention) is an opposed surface which faces the front surface Wf of the substrate, and which includes a gas injection outlet 39. Disposed inside the opposed section 3b is a manifold 40 which is linked to the solvent gas supply unit 43. As the solvent gas supply unit 43 operates in response to an operation command received from the control unit 4, the solvent gas is supplied to the manifold 40 from the solvent gas supply unit 43. The solvent gas is thereafter injected toward the upstream-side edge 231 of the liquid-tight layer 23 through the gas injection outlet 39 from the manifold 40. Hence, the solvent gas injected at the gas injection outlet 39, after contacting the upstream-side edge 231 of the liquid-tight layer 23, gets discharged to the upstream side (+X) in the moving direction or to the side relative to the moving direction, i.e., toward the width direction, via the space which is between the bottom surface 38 of the opposed section 3b and the front surface Wf of the substrate. This forms an even flow of the solvent gas and prevents the solvent gas from staying stagnant. It is therefore possible to suppress generation of particles, uniformly supply the solvent gas to the upstream-side interface 231a and evenly dry the front surface Wf of the substrate.

### Fifth Embodiment

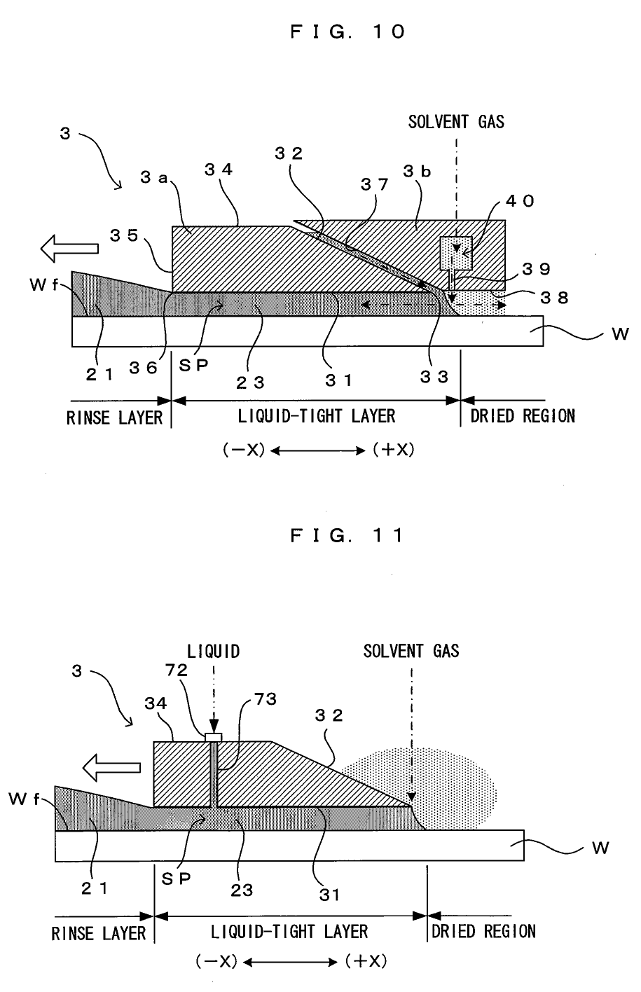

FIG. 10 is a drawing of a substrate processing apparatus according to the fifth embodiment of the invention. A major difference of the substrate processing apparatus according to the fifth embodiment from the fourth embodiment is that the liquid is supplied to the proximity block 3 before the proximity block 3 scans the front surface Wf of the substrate instead of supplying the liquid to the proximity block 3 from the liquid nozzle 71 while moving the proximity block 3. The structures and the operations are otherwise basically similar to those according to the fourth embodiment.

In this embodiment, the liquid is supplied between the side surface (extending surface) 32 and the guide surface 37 immediately before the proximity block 3 comes to its initial position in the moving direction, i.e., disposed opposed against the front surface Wf of the substrate and scans the front surface Wf of the substrate. As the proximity block 3 scans the front surface Wf of the substrate, that is, as the proximity block 3 moves in the moving direction from its initial position above, the liquid flows down gradually to the upstream side portion 33 from between the side surface (extending surface) 32 and the guide surface 37 and is accordingly supplied to the upstream-side interface 231a. Since the amount of the liquid supplied to the upstream-side interface 231a which is adjacent to the dried region is very small, the liquid held in this fashion between the side surface 32 and the guide surface 37 sufficiently dries the entire front surface Wf of the substrate. In addition, it is desirable that the angle between the opposed surface 31 and the side surface 32 is optimized so as to supply an appropriate amount of the liquid continuously to the upstream-side interface 231a during drying of the entire surface of one substrate.

According to this embodiment, since it is possible to make the liquid flow down to the upstream-side interface 231a of the liquid-tight layer 23 while trapping the liquid between the side surface 32 and the guide surface 37 as in the fourth embodiment, it is possible to ensure that the liquid flows uniformly even though the amount of the liquid guided toward the upstream side portion 33 is very small. Hence, it is possible to maintain the amount of the liquid supplied to the upstream-side interface 231a constant and evenly dry the front surface Wf of the substrate. In addition, it is possible to simplify the structure of the apparatus as the liquid nozzle 71 needs not move in synchronization to the proximity block 3.

<Others>

The invention is not limited to the embodiments described above but may be modified in various manners in addition to the embodiments above, to the extent not deviating from the object of the invention. For instance, although the proximity block 3 has a shape like a rod which is as wide as or wider than the substrate W in the embodiments described above, the outer shape of the proximity block 3 is not limited to this but may for instance be like a semi-circular ring which matches with the outer peripheral shape of the substrate W. Further, while the embodiments described above require executing drying while moving the proximity block 3 with the substrate W fixed, the substrate as well may move relative to the proximity block at the same time. Alternatively, the proximity block 3 may be fixed and the substrate W alone may be moved. The requirement in this regard is that the proximity block 3 moves in the moving direction relative to the substrate W in a state that the space SP between the opposed surface 31, which is spaced apart from the front surface Wf of the substrate, and the front surface Wf of the substrate is filled up with the rinsing liquid and the liquid-tight layer 23 is accordingly formed.

Further, although the embodiments described above require that the entire front surface Wf of the substrate is puddled with the rinsing liquid before drying, puddling of the entire front surface Wf of the substrate with the rinsing liquid before drying is not limiting. For example, the front surface Wf of the substrate seating a few scattered water droplets may be dried after rinsing, to thereby supply the liquid to the front surface Wf of the substrate from the liquid nozzle 7 or 71 and replace the liquid (the droplets) contacting the front surface Wf of the substrate with thus supplied liquid.

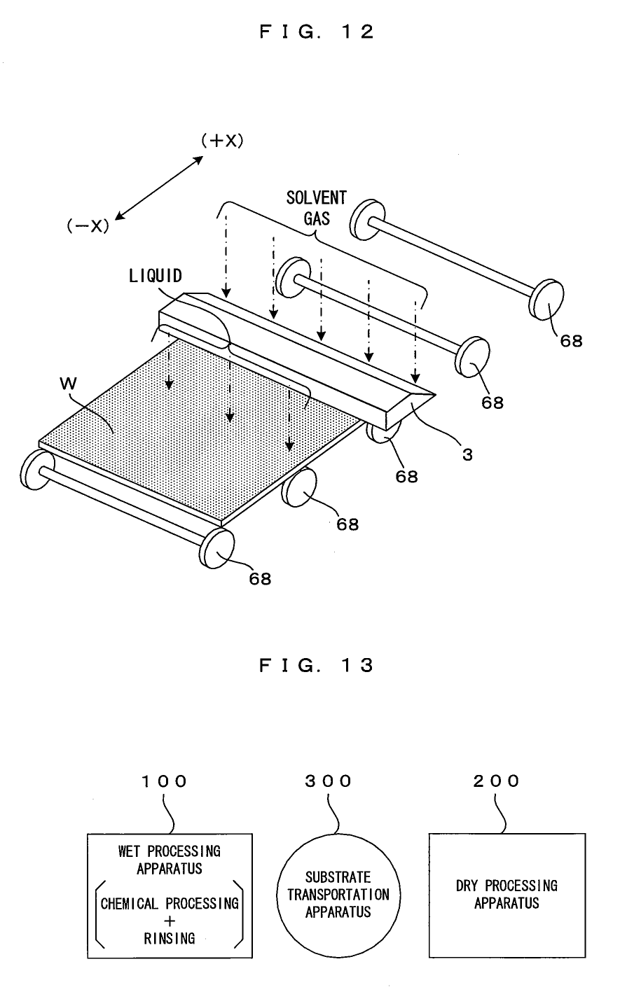

Further, although the first and the second embodiments described above require supplying the liquid from the liquid nozzle 7 to the front surface Wf of the substrate on the downstream side (−X) in the moving direction relative to the proximity block 3, the method of supplying the liquid is not limited to this. As shown in FIG. 11 for instance, one or multiple liquid supply port 72 may be disposed to the top surface 34 of the proximity block 3 to supply the liquid to the liquid-tight layer 23 via the inside of the proximity block 3. The liquid supply port 72 is connected with a supply path 73 which is disposed inside the proximity block 3. Further, the liquid supply port 72 is linked to the liquid supply unit 45. Operating in response to an operation command received from the control unit 4, the liquid supply unit 45 supplies the liquid to SP between the proximity block 3 and the front surface Wf of the substrate via the liquid supply port 72 and the supply path 73. Therefore, as the liquid is additionally supplied to the liquid-tight layer 23, the additionally supplied fresh liquid replaces the liquid staying on the front surface Wf of the substrate. In consequence, as in the embodiments described above, the amount of eluting materials contained in the liquid which is on the front surface of the substrate is suppressed, which in turn effectively prevents generation of a water mark.

As for the shape of the proximity block 3, while the proximity block is structured so that the side surface 32 (extending surface) is at the acute angle θ with respect to the opposed surface 31 in the embodiments described above, the shape of the proximity block 3 is not limited to this: for instance, the side surface 32 may be at a right angle with respect to the opposed surface 31. In the event that the side surface 32 is at a right angle with respect to the opposed surface 31, since the liquid can not stay on the side surface 32, it is necessary to execute drying while supplying the liquid from the liquid nozzle 7 or 71 as described in the first through the fourth embodiments.

Further, although the embodiments described above require executing drying of the substrate W which is approximately disk-shaped, an object to be processed with the substrate processing apparatus according to the invention is not limited to this. For instance, the invention is applicable also to a substrate processing apparatus which dries a surface of a rectangular substrate such as a glass substrate for liquid crystal display. As shown in FIG. 12 for instance, plural transportation rollers 68 corresponding to the “driver” of the invention may be disposed in the transportation direction (+X) and a proximity block 3 having the identical structure to that according to the embodiments described above may be fixed while the transportation rollers 68 transport the substrate W. While the “predetermined moving direction” of the invention corresponds to the opposite direction (−X) to the transportation direction since the substrate W is transported along the transportation direction (+X) in such a substrate processing apparatus, basic operations are exactly the same as those in the embodiments described above and similar effects are obtained.

Further, although the embodiments described above require executing wet processing such as chemical processing and rinsing of the substrate W which is held by the spin chuck 1 and thereafter executing drying of the rinsed substrate within the same apparatus with the proximity block 3 scanning in the moving direction, the wet processing and the drying processing may be performed separately from each other. Specifically, as shown in FIG. 13, a wet processing apparatus 100 for performing chemical processing and rinsing of the substrate W may be disposed over a certain distance from a dry processing apparatus 200 in which the proximity block 3 is incorporated and dries the substrate W, and a substrate transportation apparatus 300 may transport the substrate finally rinsed by the wet processing apparatus 100 to the dry processing apparatus 200 for execution of drying.

Further, although the embodiments described above require executing drying of the substrate W whose front surface Wf to be dried is directed toward above while moving the proximity block 3 in the moving direction relative to the substrate, the posture of the substrate is not limited to this.

Further, in the embodiments above, although drying is performed to the substrate surface Wf which is wet with the rinsing liquid, the invention is applicable also to a substrate processing apparatus which dries the substrate surface which is wet with other liquid than the rinsing liquid.

The invention is applicable to a substrate processing apparatus which dries a surface of any general substrate which may be a semiconductor wafer, a glass substrate for photomask, a glass substrate for liquid crystal display, a glass substrate for plasma display, a substrate for an optical disk, etc.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A substrate processing apparatus which dries a surface of a substrate which is wet with a liquid, said apparatus comprising:
a proximity member which includes an opposed surface disposed facing the surface of the substrate but away from the surface of the substrate, and which is structured to move freely and relatively to the substrate in a predetermined moving direction in a condition that a space between the opposed surface and the surface of the substrate is filled with the liquid to form a liquid-tight layer;
a driver which moves said proximity member relatively to the substrate in the moving direction;
a solvent gas supplier which supplies a solvent gas toward an end portion of the liquid-tight layer on the upstream-side in the moving direction, the solvent gas necessarily containing a solvent component which is dissolved in the liquid and reduces the surface tension; and
a liquid supplier which supplies the liquid toward the surface of the substrate at an upstream-side interface of the liquid-tight layer or on the downstream-side in the moving direction relative to the upstream-side interface, thereby replacing the liquid staying on the surface of the substrate with thus supplied liquid.

2. The substrate processing apparatus of claim 1, wherein said liquid supplier includes a first nozzle which discharges the liquid toward the surface of the substrate on the downstream side in the moving direction relative to said proximity member.

3. The substrate processing apparatus of claim 1, wherein said liquid supplier includes a second nozzle which discharges the liquid toward a non-opposed surface of said proximity member which is exclusive of the opposed surface, and
said proximity member guides along the non-opposed surface the liquid, which has been discharged from said second nozzle to the non-opposed surface, toward an upstream side portion which is located on the upstream side in the moving direction among side portions defining the opposed surface.

4. The substrate processing apparatus of claim 3, wherein said proximity member guides along the non-opposed surface the liquid, which has been discharged from said second nozzle to the non-opposed surface, toward the upstream side portion and toward a downstream side portion which is located on the downstream side in the moving direction among side portions defining the opposed surface.

5. The substrate processing apparatus of claim 3, wherein said proximity member further includes an extending surface which is connected as the non-opposed surface with the upstream side portion and which extends from the position of connection with the upstream side portion in a direction away from the surface of the substrate overlooking the upstream side in the moving direction, and said proximity member guides the liquid which has been discharged from said second nozzle, toward the upstream side portion via the extending surface.

6. The substrate processing apparatus of claim 5, wherein at an upstream-side end portion of said proximity member, the opposed surface and the extending surface are at an acute angle.

7. The substrate processing apparatus of claim 5, wherein said proximity member includes a guide surface which faces the extending surface and guides the liquid to the upstream side portion, and said proximity member guides the liquid toward the upstream side portion while the liquid discharged from said second nozzle attains a liquid-tight state between the extending surface and the guide surface.

8. The substrate processing apparatus of claim 1, wherein said solvent gas supplier includes a cover member which surrounds an upstream-side atmosphere which is located on the upstream side in the moving direction relative to the liquid-tight layer, and said solvent gas supplier supplies the solvent gas to the upstream-side atmosphere.

9. The substrate processing apparatus of claim 1, wherein said proximity member further includes an upstream-side opposed section which has a gas injection outlet and faces but spaced apart from the surface of the substrate on the upstream side in the moving direction relative to the opposed surface, and
said solvent gas supplier injects from the gas injection outlet the solvent gas toward the upstream side of the liquid-tight layer in the moving direction.

10. The substrate processing apparatus of claim 1, wherein said proximity member is made of quartz.

11. A substrate processing method of drying a surface of a substrate which is wet with a liquid, said method comprising the steps of:
arranging a proximity member which includes an opposed surface which faces the surface of the substrate, in such a manner that the opposed surface is spaced apart from the surface of the substrate, filling up a space between the opposed surface and the surface of the substrate with the liquid and accordingly forming a liquid-tight layer;
moving said proximity member in a predetermined moving direction relative to the substrate while maintaining the condition that the liquid-tight layer is formed;
supplying a solvent gas toward an end portion of the liquid-tight layer on the upstream side in the moving direction, the solvent gas necessarily containing a solvent component which is dissolved in the liquid and reduces the surface tension; and
supplying the liquid toward the surface of the substrate at an upstream-side interface of the liquid-tight layer or on the downstream side in the moving direction relative to the upstream-side interface, thereby replacing the liquid contacting the surface of the substrate with thus supplied liquid.
